(19) United States
(12) Patent Application Publication
(10) Pub. No.: US 2007/0183442 A1
(43) Pub. Date: Aug. 9, 2007

(54) Communications system and communication control method

(76) Inventor: Takayuki Shibata, Tokyo (JP)

Correspondence Address: DICKSTEIN SHAPIRO LLP, 1177 AVENUE OF THE AMERICAS (6TH AVENUE), NEW YORK, NY, 10036-2714, US

(21) Appl. No.: 10/597,924

(22) PCT Filed: Feb. 14, 2005
(86) PCT No.: PCT/JP05/02120

§ 371 Date: Aug. 11, 2006

(30) Foreign Application Priority Data
Feb. 12, 2004 (JP) 2004-034348

(51) Int. Cl. H04J 3/16

(52) U.S. Cl. 370/437

(57) ABSTRACT

In a communications system for adaptively controlling a modulation mode and encoding rate for data transmitted from a transmitter to a receiver, the transmitter comprises adaptive modulation control means for controlling the modulation mode and encoding rate in accordance with the channel quality notified from the receiver, and transmission power control means for controlling a transmission power ratio of the control channel to a data channel in accordance with a control channel error detection result notified from the receiver and the modulation mode and encoding rate.

### TECHNICAL FIELD

The present invention relates to an adaptive modulation communication scheme for adaptively controlling a modulation mode and an encoding rate for data transmitted from a transmitter to a receiver, and more particularly, to a communications system based on such an adaptive modulation communication scheme, a communication control method in such a communications system, and a transmitter and a transmission control method for use in such a communications system.

### BACKGROUND ART

Mobile communications systems are required to realize increasingly faster transmissions, and a variety of technologies are being developed for this purpose. One of those is an adaptive modulation (AMC: Adaptive Modulation and Coding) communication scheme which adaptively switches a modulation mode and an encoding rate (MCS: Modulation and Coding Scheme) of data transmission.

Generally, modulation modes have natures that a larger multi-level value or encoding rate R results in a larger amount of information which can be transmitted, but in a lower error resistance. A multi-level value indicates how many number of bits are represented by one symbol in a modulation signal, and the encoding rate indicates the proportion of the total number of bits in a bit sequence after error correction encoding to the number of information bits. Therefore, when a channel quality is high, a higher throughput is exhibited by MCS which has a larger multi-level value or encoding rate, whereas when a channel quality is low, a higher throughput is exhibited by MCS which has a smaller multi-level value or encoding rate because of its higher error tolerance. According to AMC, efficient data transmissions can be accomplished by adaptively selecting MCS which realizes a maximum throughput in accordance with a channel quality.

A conventional adaptive modulation communications apparatus using AMC is disclosed, for example, in JP-A-2002-84329. FIGS. 1 and 2 illustrate an exemplary configuration of a conventional adaptive modulation communications apparatus which has a data transmission-side apparatus and a data reception-side apparatus.

As illustrated in FIG. 1, the data transmission-side apparatus comprises MCS determination unit 101, control channel transmission processing unit 102, data channel transmission processing unit 103, pilot channel transmission processing unit 104, multiplexer 105, radio transmission unit 106, antenna 107, radio reception unit 117, pilot channel reception processing unit 118, and control channel reception processing unit 119. On the other hand, the data reception-side apparatus comprises antenna 108, radio reception unit 109, pilot channel reception processing unit 110, control channel reception processing unit 111, data channel reception processing unit 112, control channel transmission processing unit 113, pilot channel transmission processing unit 114, multiplexer 115, and radio transmission unit 116, as illustrated in FIG. 2. A data channel is established from the transmission-side apparatus to the reception-side apparatus, and a control channel and a pilot channel are bidirectionally established between the transmission-side apparatus and reception-side apparatus.

In the data transmission-side apparatus, MCS determination unit 101 determines MCS for a transmission data channel in accordance with a channel quality. As the channel quality, a signal to interference power ratio (SIR) is used by way of example. Control channel transmission processing unit 102 performs processing such as encoding, modulation and the like of control information for notifying the data reception-side apparatus of the MCS for the transmission data channel to generate a control channel. Data channel transmission processing unit 103 performs processing such as encoding, modulation and the like of transmission data based on the MCS determined in MCS determination unit 101 to generate a data channel. Pilot channel transmission processing unit 104 generates a pilot channel for use in timing detection, estimation of a transmission path, SIR measurement and the like in the reception-side apparatus. The data channel, control channel, and pilot channel thus generated are multiplexed in multiplexer 105, subjected to processing such as D/A (digital/analog) conversion, frequency conversion to a radio frequency band, and the like in radio transmission unit 106, and transmitted over the air to the data reception-side apparatus through antenna 107.

A signal transmitted from the data transmission-side apparatus is received in the data reception-side apparatus through antenna 108, and subjected to processing such as frequency conversion to a baseband, A/D (analog/digital) conversion, and the like in radio reception unit 109. Pilot channel reception processing unit 110 detects a path timing of the received signal and estimates a transmission path, and supplies the path timing and the transmission path estimation result to control channel reception processing unit 111 and data channel reception processing unit 112. Pilot channel reception processing unit 110 also measures SIR from the transmission path estimation result, and supplies the measured SIR to control channel transmission processing unit 113.

Control channel reception processing unit 111 performs processing such as demodulation, decoding and the like of the control channel using the path timing and transmission path estimation result to acquire MCS information of the data channel, and supplies this MCS information to data channel reception processing unit 112. Data channel reception processing unit 112 performs processing such as demodulation, decoding and the like of the data channel using the path timing, transmission path estimation result, and MCS information to deliver received data. Control channel transmission processing unit 113 performs processing such as encoding, modulation and the like of control information for notifying the data transmission-side apparatus of the SIR measurement result to generate a control channel. Pilot channel transmission processing unit 114 generates a pilot channel for use in timing detection, transmission path estimation and the like in the data transmission-side apparatus. The control channel and pilot channel thus generated are multiplexed in multiplexer 115, subjected to processing such as D/A conversion, frequency conversion to radio frequency band, and the like in radio transmission.unit 116, and transmitted over the air to the data transmission-side apparatus through antenna 108.

A signal transmitted from the data reception-side. apparatus is received in the data transmission-side apparatus through antenna 107, and subjected to processing such as frequency conversion to the baseband, AID conversion and the like in radio reception unit 117. Pilot channel reception processing unit 118 of the data transmission-side apparatus detects a path timing and estimates a transmission path of the received signal, and supplies the path timing and transmission path estimation result to control channel reception processing unit 119. Controi channel reception processing unit 119 performs processing such as demodulation, decoding and the like of a control channel using the path timing and transmission path estimation result to acquire SIR information which is supplied to MCS determination unit 101.

### DISCLOSURE OF THE INVENTION

### Problems to be Solved by the Invention

As described above, in the conventional adaptive modulation, MCS information of a data channel is notified from a data transmission-side apparatus to a data reception-side apparatus, and the data reception-side apparatus demodulates and decodes data based on the acquired MCS information. Therefore, if errors occur on a control channel including the MCS information, data cannot be demodulated or decoded, giving rise to a problem of a reduction in throughput as the overall communications system. Also, as shown in the aforementioned JP-A-2002-84329, a technique has been proposed for performing demodulation and decoding in a data reception-side apparatus without notification of MCS information, but a problem arises in that a circuit scale of the data reception-side apparatus significantly increases when such a technique is used. For avoiding these problems, it is necessary to transmit the control channel at a considerably high quality. However, the transmission of a control channel at a high quality at all times is a waste of resources.

It is an object of the. present invention to provide a communications system and a communication control method which are capable of preventing a degradation in throughput and effectively utilizing resources by transmitting a control channel at a high quality only when it is required without largely increasing a circuit scale.

It is another object of the present invention to provide a transmitter and a transmission control method for use in such a communications system.

### Means for Solving the Problems

The first object of the present invention is achieved by a communications system for adaptively controlling a modulation mode and an encoding rate for data transmitted from a transmitter to a receiver, wherein the receiver comprises channel quality measuring means for measuring a channel quality, and control channel error detecting means for detecting an error of a control channel, and the transmitter comprises adaptive modulation control means for controlling the modulation mode and encoding rate in accordance with the channel quality notified from the receiver, and transmission power control means for controlling a transmission power ratio of the control channel to a data channel in accordance with a control channel error detection result notified from the receiver and the modulation mode and encoding rate.

The first object of the present invention is.also achieved by a communication control method for adaptively controlling a modulation mode and an encoding rate for data transmitted from a transmitter to a receiver, where the method comprises the steps of measuring a channel quality in the receiver, detecting a control channel error in the receiver, notifying the channel quality and the control channel error from the receiver to the transmitter, controlling, in the transmitter, a modulation mode and an encoding rate in accordance with the channel quality notified from the receiver, and controlling, in the transmitter, a transmission power ratio of a control channel to a data channel in accordance with a control channel error detection result notified from the receiver and the modulation mode and encoding rate.

The second object of the present invention is achieved by a transmitter for adaptively controlling a modulation mode and an encoding rate for data transmitted to a receiver, where the transmitter comprises adaptive modulation control means for controlling a modulation mode and an encoding rate in accordance with a channel quality notified from the receiver, and transmission power control means for controlling a transmission power ratio of a control channel to a data channel in accordance with a control channel error detection result notified from the receiver and the modulation mode and encoding rate.

The second object of the present invention is also achieved by a transmission control method in a transmitter for adaptively controlling a modulation mode and an encoding rate for data transmitted to a receiver, where the method comprises the steps of controlling the modulation mode and encoding rate in accordance with a channel quality notified from the receiver, and controlling a transmission power ratio of a control channel to a data channel in accordance with a control channel error detection result notified from the receiver and the modulation mode and encoding rate.

In the present invention, the transmission power for a control channel is increased/decreased in accordance with the error ratio and. channel quality. Specifically, an appropriate control channel transmission power is set in accordance with MCS which reflects the quality, and the control channel transmission power is increased/decreased in accordance with a control channel error ratio, thereby transmitting the control channel at a high quality only when it is required. In this way, according to the present invention, a lower throughput of the data channel due to control channel errors can be prevented when the quality is low, whereas the power of the control channel can be saved when the quality is high, thus making it possible to effectively utilize resources.

### BRIEF DESCRIPTION OF THE DRAWINGS

FIG. 1 is a block diagram illustrating an exemplary configuration of a transmission-side apparatus in a conventional adaptive modulation communications apparatus.

FIG. 2 is a block diagram illustrating an exemplary configuration of a reception-side apparatus in the conventional adaptive modulation communications apparatus.

FIG. 3 is a block diagram illustrating the configuration of a transmitter in an adaptive modulation communications apparatus according to one embodiment of the present invention.

FIG. 4 is a block diagram illustrating the configuration of a receiver in the adaptive modulation communications apparatus according to one embodiment of the present invention.

FIG. 5 is a diagram showing an exemplary correspondence of SIR to MCS.

FIG. 6 is a block diagram illustrating the configuration of a transmission power determination unit in the transmitter illustrated in FIG. 3.

FIG. 7 is a block diagram illustrating the configuration of a control channel transmission processing unit in the transmitter illustrated in FIG. 3.

FIG. 8 is a block diagram illustrating the configuration of a pilot channel reception processing unit in the receiver illustrated in FIG. 4.

FIG. 9 is a block diagram illustrating the configuration of a control channel reception processing unit in the receiver illustrated in FIG. 4.

FIG. 10 is a flow chart illustrating a process for determining transmission power ratios of a control channel and a pilot channel to a data channel.

FIG. 11 is a.graph showing an exemplary relationship between a control channel error ratio and fluctuations in the transmission power ratio of the control channel and pilot channel to the data channel.

FIG. 12 is a graph showing an exemplary relationship between the transmission power ratios of the control channel and pilot channel to the data channel and MCS.

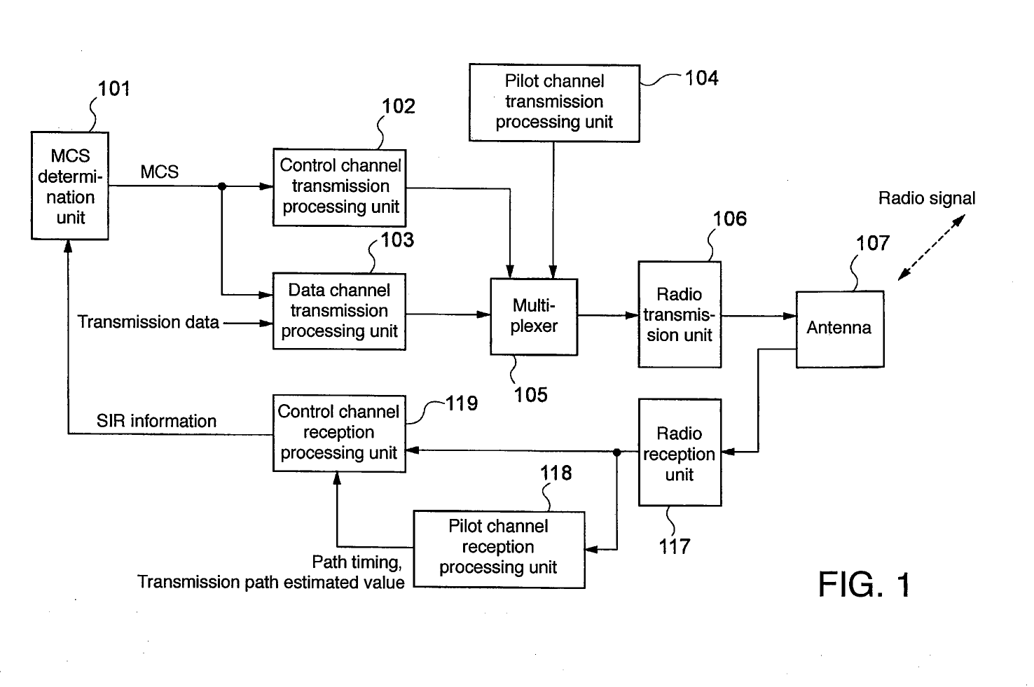

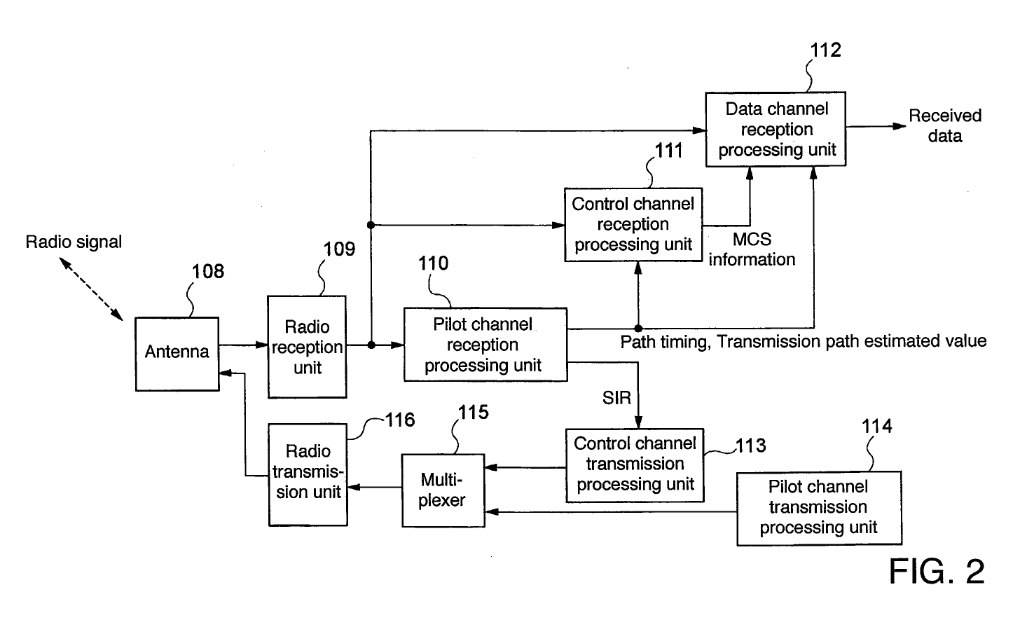

### BEST MODE FOR CARRYING OUT THE INVENTION

An adaptive modulation communications apparatus according to a preferred embodiment of the present invention has a transmitter and a receiver, and transmits data over the air from the transmitter to the receiver.

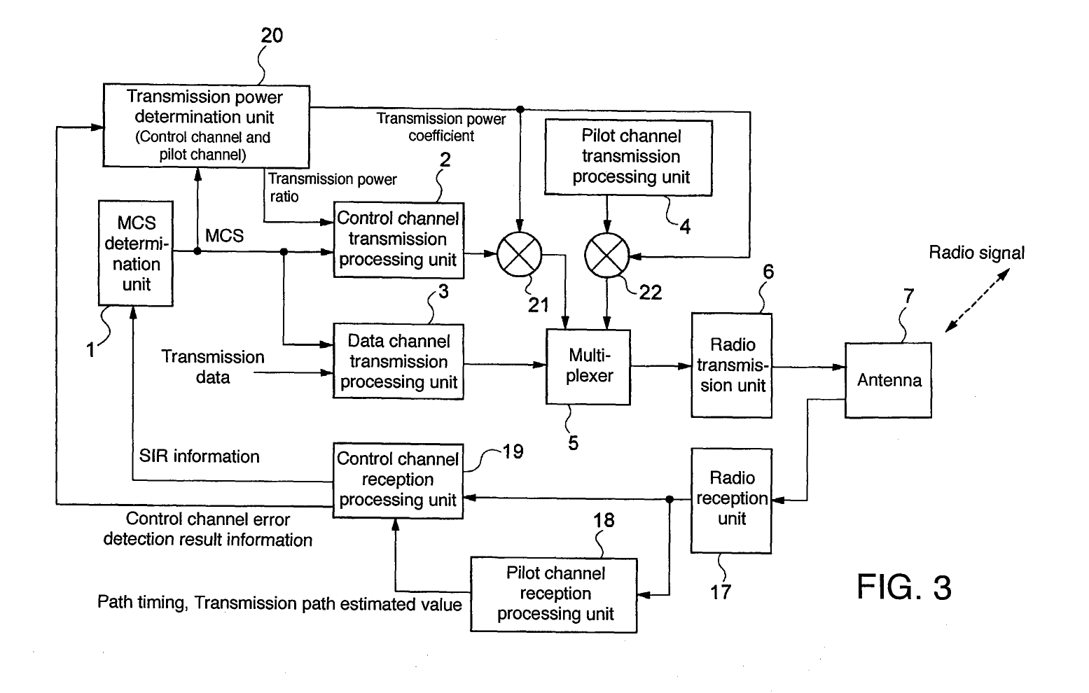

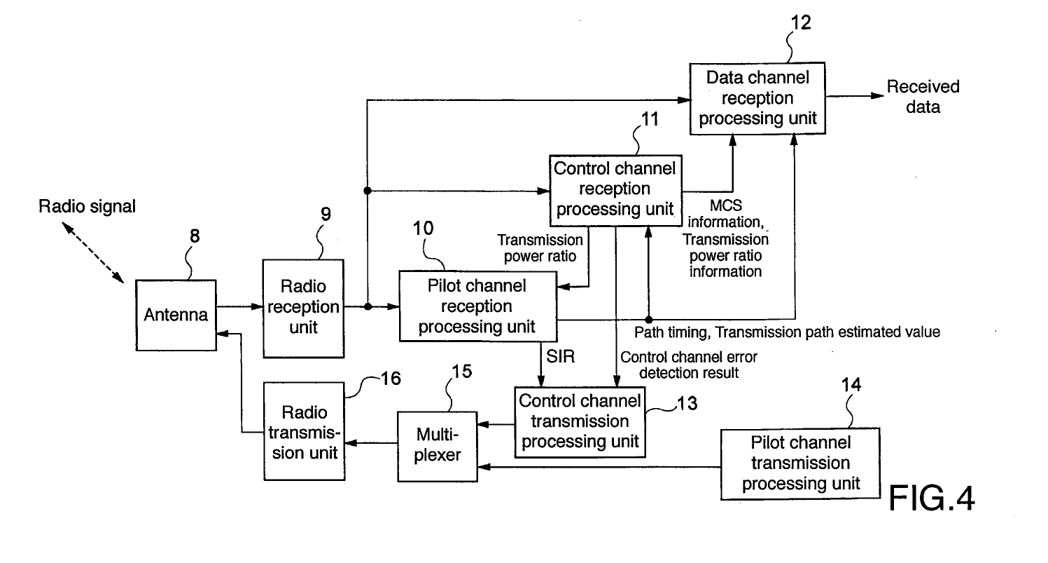

As illustrated in FIG. 3, the transmitter comprises MCS determination unit 1, control channel transmission processing unit 2, data channel transmission processing unit 3, pilot channel transmission processing unit 4, multiplexer 5, radio transmission unit 6, antenna 7, radio reception unit 17, pilot channel reception.processing unit 18, control channel reception processing unit 19, transmission power determination unit 20, and multipliers 21, 22. On the. other hand, the receiver comprises antenna 8, radio reception unit 9, pilot channel reception processing unit 10, control channel reception processing unit 1.1, data channel reception processing unit 12, control channel transmission processing unit 13, pilot channel transmission processing unit 14, multiplexer 15, and radio transmission unit 16, as illustrated in FIG. 4. A data channel is set from the transmission-side apparatus to the reception-side apparatus, and a control channel and a pilot channel are bidirectionally established between the transmission-side apparatus and reception-side apparatus.

First, the transmitter will be described in detail.

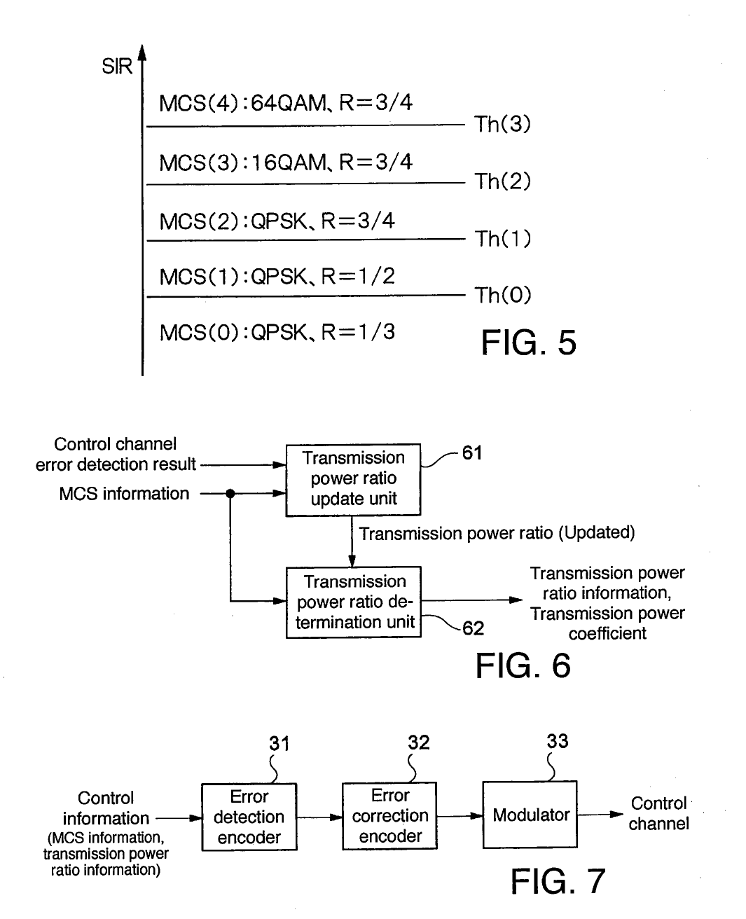

MCS determination unit 1 of the transmitter determines MCS for a transmission data channel in accordance with a channel quality measured by the receiver. As a channel quality, SIR may be given by way of example. Assume, for example, that there have been previously set four thresholds Th(0) to Th(3) and five combinations of MCS, MCS(0) to MCS(4), as shown in FIG. 5. MCS(0) to MCS(2) employ QPSK (Quadrature Phase Shift Keying) for a modulation mode, but differ in coding rate R. MCS(3) employs 16QAM (16-Quadrature Amplitude Modulation) for a modulation mode, while MCS(4) employs 64QAM (64-Quadrature Amplitude Modulation) for a modulation mode. MCS determination unit 1 selects MCS(0) for the MCS combination when SIR is lower than Th(0); selects MCS(k) (k=1, 2, 3) for the MCS combination when SIR is equal to or higher than Th(k−1) and lower than Th(k); and selects MCS(4) for the MCS combination when SIR is equal to or higher than Th(3).

Transmission power determination unit 20 determines a transmission power ratio of a control channel to a data channel from the transmitter to the receiver, and a transmission power ratio of a pilot channel to the data channel from the transmitter to the receiver in accordance with the MCS determined by MCS determination unit 1 and a control channel error detection result notified from the receiver. In this embodiment, the transmission power of the pilot channel is controlled in a similar manner to the transmission power of the control channel, and the transmission power ratio of the control channel to the data channel is the same as the transmission power ratio of the pilot channel to the data channel. The transmission powers of the control channel and pilot channel from the transmitter to the receiver are both controlled based on the transmission power ratios thus determined in a form of the ratio to the transmission power of the data channel. Specifically, as illustrated in FIG. 6, transmission power determination unit 20 comprises transmission power ratio update unit 61 and transmission power ratio determination unit 62. The transmission power ratio of the control channel and pilot channel to the data channel has been previously set in transmission power ratio update unit 61 on a MCS-by-MCS basis. Transmission power ratio update unit 61 periodically updates the transmission power ratio in accordance with a control channel error detection result. Transmission power ratio determination unit 62 determines the transmission power ratio in accordance with the MCS, and delivers transmission power ratio information and a transmission power coefficient. As later described, the transmission power ratio information is communicated to the receiver through the control channel. The transmission power coefficient is multiplied in amplitude by the control channel and pilot channel, and is represented by a square root of the transmission power ratio represented in antilogarithm value.

Control channel transmission processing unit 2 performs processing such as encoding, modulation and the like of control information to generate a control channel. The control information is provided for notifying the receiver of MCS for a transmission data channel, and a transmission power ratio of the control channel and pilot channel to the data channel. Therefore, control channel transmission processing unit 2 receives MCS information from MCS determination unit 1, and transmission power ratio information from transmission power determination unit 20. As illustrated in FIG. 7, error detection encoder 31, error correction encoder 32, and modulator 33 are connected in series in control channel transmission processing unit 2. The control information is encoded by error detection encoder 31 and error correction encoder 32,; and the encoded control information is modulated by modulator 33, thereby generating a control channel. The error detection code is, for example, a CRC (Cyclic Redundancy Check) code, and the error correction code is, for example, a convolutional code. The generated control channel is sent to multiplier 21.

Data channel transmission processing unit 3 performs processing such as encoding, modulation and the like of transmission data based on the MCS determined by MCS determination unit 1, to generate a data channel. Data channel transmission processing unit 3 receives transmission data and also receives the MCS information from MCS determination unit 1. The generated data channel is sent to multiplexer 5.

Pilot channel transmission processing unit 4 generates a pilot channel for use in timing detection, transmission path estimation, SIR measurement and the like in the receiver. The generated pilot channel is sent to multiplier 22.

Multiplier 21 multiplies the control channel by the transmission power coefficient for the control channel, and supplies the result to multiplexer 5. Likewise, multiplier 22 multiplies the pilot channel by the transmission power coefficient for the pilot channel, and supplies the result to multiplexer 5. As described above, the transmission power coefficients for the control channel and pilot channel are determined, respectively, based on the transmission power ratios of the control channel and pilot channel to the data channel.

Multiplexer 5 multiplexes the data channel supplied from data channel transmission processing unit 3, the control channel supplied from multiplier 2, and the pilot channel supplied from multiplier 22. The multiplexed data is subjected to processing such as D/A conversion, frequency conversion to a radio frequency band, and the like in radio transmission unit 6, and is transmitted to the receiver side through antenna 7 as a radio signal. Antenna 7 has functions of transmitting the output from radio transmission unit 6 to the receiver and receiving a signal sent from the receiver as well.

In the transmitter, a signal transmitted from the receiver side is sent from antenna 7 to radio reception unit 17. Radio reception unit 17 performs processing such as frequency conversion to a baseband, A/D conversion and the like bf the received radio signal. Pilot channel reception processing unit 18 detects a path timing and estimates a transmission path of the received signal, and supplies the path timing and transmission path estimation result to control channel reception processing unit 19. Control channel reception processing unit 19 performs processing such as demodulation, decoding and the like of a control channel using the path timing and transmission path estimation result to acquire SIR information and control channel error detection result, supplies the SIR information to MCS determination unit 1, and supplies the control channel error detection result to transmission power determination unit 20.

Next, the receiver will be described in detail.

A signal transmitted from the transmitter is received in the receiver through antenna 8, and sent to radio reception unit 9. As later described, antenna 8 has a function of transmitting the output from radio transmission unit 16 to the transmitter side in addition to a function of receiving a signal from the transmitter. Radio reception unit 9 performs processing such as frequency conversion to the baseband, A/D conversion and the like of the received radio signal, and sends the processed signal to pilot channel reception processing unit 10, control channel reception processing unit 11, and data channel reception processing unit 12.

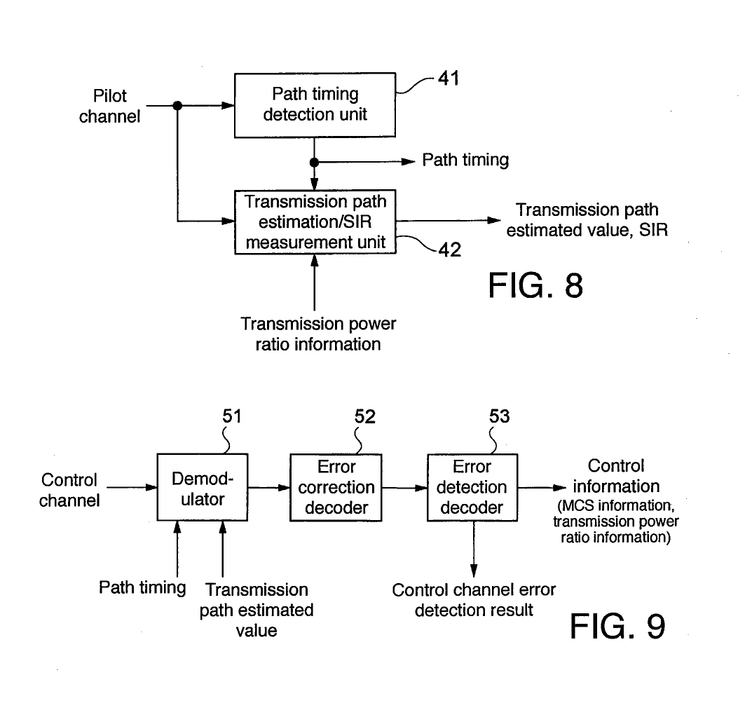

Pilot channel reception processing unit 10 detects a path timing and estimates a transmission path of the received signal, and supplies the path timing and transmission path estimation result to control channel reception processing unit 11 and data channel reception processing unit 12. Also, pilot channel reception processing unit 10 measures SIR on a data channel from the transmission path estimation result and transmission power ratio, and supplies the SIR to control channel transmission processing unit 13. As illustrated in FIG. 8, pilot channel reception processing unit 10 comprises pilot timing detection unit 41 and transmission path estimation/SIR measurement unit 42. Path timing detection unit 41 momentarily calculates correlated values of the received pilot channel with a plurality of known pilot symbols, detects a timing at which a high correlated value appears, which is delivered as a path timing. Transmission path estimation/SIR measurement unit 42 multiplies the conjugates of the known pilot symbols for each symbol of the pilot channel based on the path timing, calculates a transmission path estimated value and SIR from an average and deviation of each symbol, and delivers the transmission path estimated value and SIR. For reference, in transmission path estimation/SIR measurement unit 42, the transmission path estimated value for data channel reception processing and the SIR indicative of the channel quality on the data channel are corrected based on the transmission power ratio information before they are delivered. For this reason, pilot channel reception processing unit 10 receives transmission power ratio information from control channel reception processing unit 11, as described below.

Control channel reception processing unit 11 performs processing such as demodulation, decoding and the like of the control channel using the path timing and transmission path estimation result supplied from pilot channel reception processing unit 10, acquires MCS information and transmission power ratio information of the data channel, supplies the MCS information to data channel reception processing unit 12, supplies the transmission power ratio information to pilot channel reception processing unit 10 and data channel reception processing unit 12, and supplies a control channel error detection result to control channel transmission processing unit 13. As illustrated in FIG. 9, demodulator 51, error correction decoder 52, and error correction decoder 53 are connected in series in control channel reception processing unit 11. Demodulator 51 demodulates the control channel using the path timing and transmission path estimation result. Error correction decoder. 52 decodes the demodulated control channel, for example, in accordance with a Viterbi decoder. Error detection decoder 53 detects the presence or absence of errors in the output of error correction decoder 52, for example, in accordance with CRC, and delivers a control channel error detection result and decoded control information. If an error is detected in the control channel, no control information can be provided, so that error detection decoder 53 supplies control information received at the preceding time.

Data channel reception processing unit 12 performs processing such as demodulation, decoding and the like of the data channel using the path timing and transmission path estimation result from pilot channel reception processing unit 10, and the MCS information and transmission power ratio information from the control channel reception processing unit, to generate received data.

Control channel transmission processing unit 13 performs processing such as encoding, modulation and the like of control information for notifying the transmitter, to generate a control channel. Here, the control information notified to the transmitter is comprised of the SIR measurement result from pilot channel reception processing unit 10, and the control channel error detection result form control channel reception processing unit 11. The generated control channel is sent to multiplexer 15. Pilot channel transmission processing unit 14 generates a pilot channel for use in timing detection, transmission path estimation and the like in the transmitter, and supplies the pilot channel to multiplexer 15.

Multiplexer 15 multiplies the control channel and pilot channel thus generated. The multiplexed data is subjected to processing such as D/A conversion, frequency conversion to a radio frequency band, and the like in radio transmission unit 16, and transmitted to the transmission-side apparatus through antenna 8 as a radio signal.

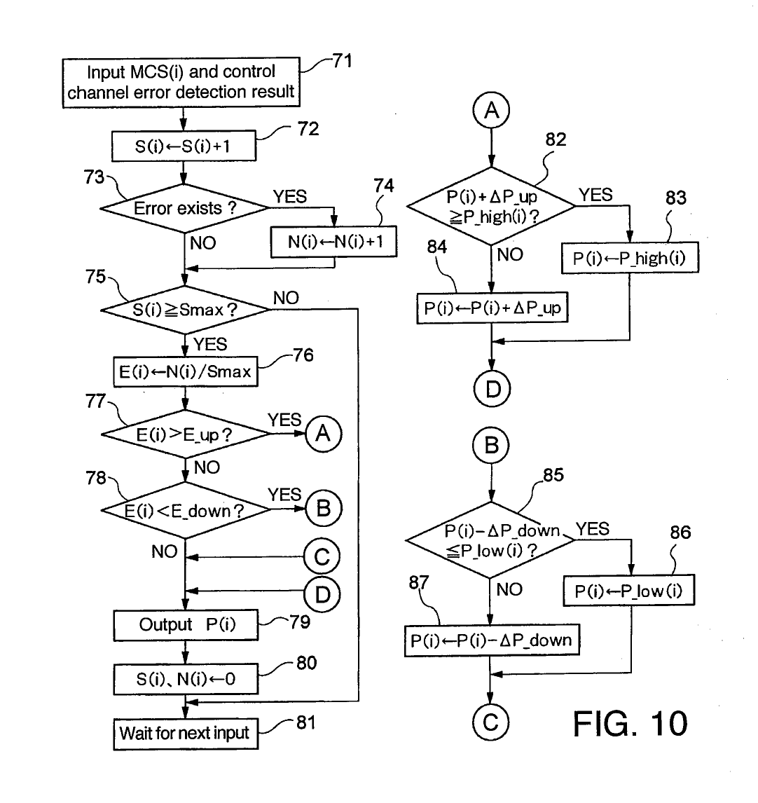

Next, a process for determining transmission powers for a control channel and a pilot channel in the transmitter will be described with reference to FIG. 10. FIG. 10 illustrates the operation of transmission power determination unit 20.

Assume in the following description that MCS(i) is supplied as MCS, where i=0, 1, 2, 3, 4. In FIG. 10, S(i) represents the number of times MCS(i) is determined, and N(i) represents the number of control channel errors when MCS(i) is determined. Each of S(i), N(i) have an initial value of zero. E(i) is a control channel error ratio when MCS(i) is determined; Smax is the number of samples when control channel error ratio E(i) is calculated; E_up is a threshold for determining that the transmission power ratio is increased; and E_down is a threshold for determining that the transmission power ratio is decreased. Here, E_up≧E_down stands. P(i) is a transmission power ratio when MCS(i) is determined, and its initial value is a previously given value. P_high(i) indicates an upper limit value within a range in which the transmission power ratio can vary for a case of MCS(i), and P_low(i) indicates a lower limit value within the range in which the transmission power ratio can vary for a case of MCS(i). Here, P_high(i)≧P_low(i) stands. ΔP_up indicates an increased width of the transmission power ratio, and ΔP_down indicates a decreased width of the transmission power ratio.

First, at step 71, MCS(i) and control channel error detection result information are supplied to transmission power determination unit 20, and at step 72, number S(i) of times MCS(i) is determined is incremented.

Next, at step 73, the presence or absence of control channel error is identified. Here, if there is any control channel error, number N(i) of control channel errors for a case of MCS(i) is incremented at step 74, followed by a transition to step 75. A transition to step 75 is also made even when there is no error at step 73.

At step 75, S(i) is compared with number Smax of samples when the number of control channel errors is calculated, and if S(i)<Smax, the process proceeds to step 81 for entering the next input. On the other hand, if S(i)≧Smax at step 75, control channel error ratio E(i) for a case of MCS(i) is calculated in accordance with E(i)=N(i)/Smax at step 76, and E(i) is compared with threshold E_up at step 77.

At step 77, if E(i)>E_up, the process proceeds to a transmission power ratio increase determination process shown at steps 82 to 84, whereas if E(i)≦E_up, E(i) is then compared with threshold E_down at step 78. At step 78, if E(i)<E_down, the process proceeds to a transmission power ratio decrease determination process shown at steps 85 to 87, whereas if E(i)≧E_down, the process proceeds to step 79 without updating transmission power ratio P(i).

Now, a description will be given of the transmission power ratio increase determination process. First, at step 82, transmission power ratio increment ΔP_up is added to current transmission power ratio P(i), and compared with upper limit value P_high(i) for a case of MCS(i). If P(i)+ΔP_up≧P_high(i), P(i) is updated to P_high(i) at step 83, followed by a transition to step 79. On the other hand, if P(i)+ΔP_up<P_high(i) at step 82, P(i) is updated to P(i)+ΔP_up at step 84, followed by a transition to step 79.

Next, a description will be given of a transmission power ratio decrease determination process. First, at step 85, transmission power ratio decrement ΔP_down is subtracted from current transmission power ratio P(i), and is compared with lower limit value P_low(i) for a case of MCS(i). If P(i)−ΔP_down≦P_low(i), P(i) is updated to P_low(i) at step 86, followed by a transition to step 79. On the other hand, if P(i)−ΔP down>P_low(i) at step 82, P(i) is updated to P(i)−ΔP_down at step 87, followed by a transition to step 79.

At step 79, P(i) updated or maintained in the foregoing manner is supplied to control channel transmission processing unit 2 as control information notified to the receiver, and is also supplied to multipliers 21, 22 as a transmission power coefficient for controlling the transmission powers of the control channel and pilot channel (step 79). Subsequently, at step 80, both S(i) and N(i) are initialized to zero, followed by a transition to step 81, where the next input is awaited.

In the foregoing manner, transmission power determination unit 20 in the transmitter controls the transmission powers of the control channel and pilot channel.

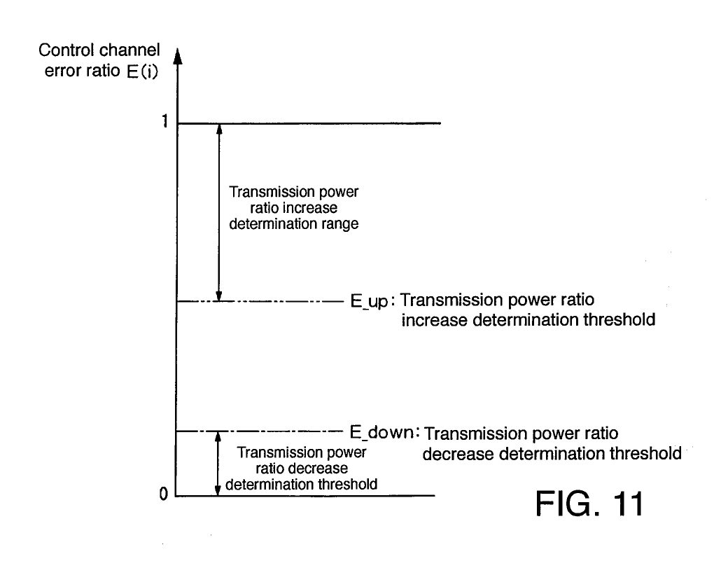

FIG. 11 shows the relationship between E(i) and E_up, E_down in the processes described above. A process for increasing or maintaining or decreasing the power ratio is executed in accordance with the magnitude relationship between E(i) and E_up, E_down.

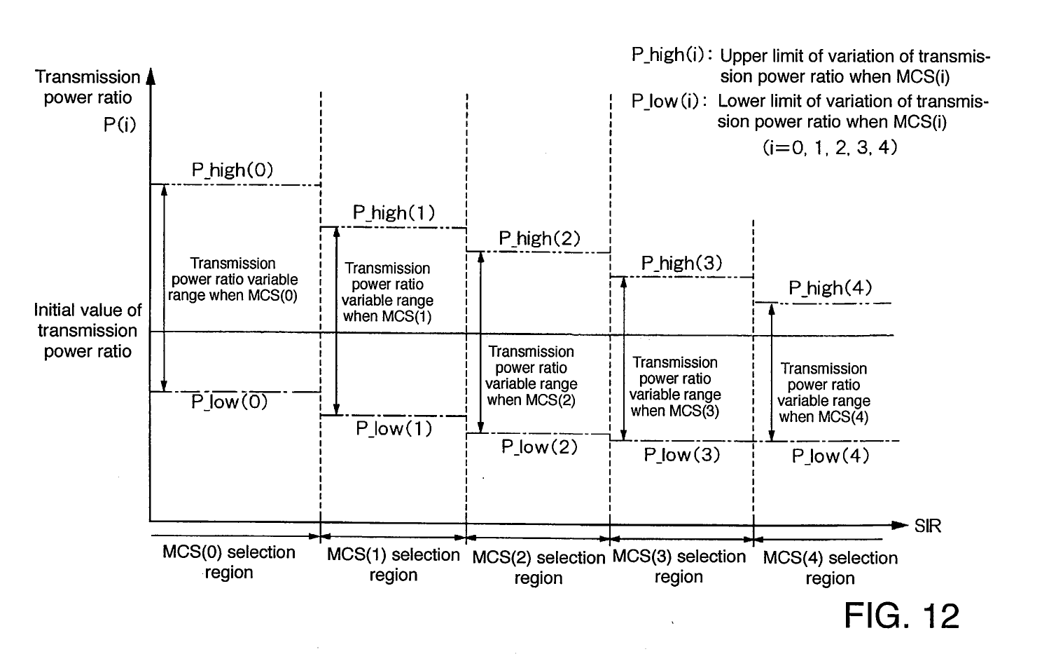

FIG. 12 shows the relationship between P(i) and P_high(i), P_low(i). The transmission power ratio fluctuates within a transmission power ratio variable range which is set independently on an MCS-by-MCS basis in accordance with the control channel error ratio. For example, a higher transmission power ratio can be set for a case of MCS(0) which is used for a poor quality, while a smaller transmission power ratio can be set for a case of MCS(4) which is used for a high quality, thereby making it possible to transmit a control channel at a high quality only when it is required to effectively utilize resources.

In the foregoing description, the transmission power ratio of the control channel to the data channel is the same as the transmission power ratio of the pilot channel to the data channel. However, when the control channel is modulated in accordance with a scheme, such as QPSK, where modulation information is carried only in the phase, the control channel can be demodulated even if the transmission power ratio of the control channel is not the same as the transmission power ratio of the pilot channel. Accordingly, the transmission power ratio of the control channel to the data channel, may be controlled independently of the transmission power ratio of the pilot channel to the data channel, or the transmission power ratio of the control channel to the data channel may only be controlled while the transmission power ratio of the pilot channel to the data channel is left fixed.

1. A communications system for adaptively controlling a modulation mode and an encoding rate for data transmitted from a transmitter to a receiver, wherein:
said receiver comprises channel quality measuring means for measuring a channel quality, and control channel error detecting means for detecting an error of a control channel, and
said transmitter comprises adaptive modulation control means for controlling the modulation mode and encoding rate in accordance with the channel quality notified from said receiver, and transmission power control means for controlling a transmission power ratio of the control channel to a data channel in accordance with a control channel error detection result notified from said receiver and the modulation mode and encoding rate.

2. The communications system according to claim 1, wherein said transmission power control means includes:
means for independently calculating a control channel error ratio for each combination of the modulation mode and encoding rate determined by said adaptive modulation control means; and
means for variably controlling the transmission power ratio of the control channel to the data channel in accordance with the control channel error ratio.

3. The communications system according to claim 1, wherein said transmission power control means controls the transmission power ratio of the control channel to the data channel within a range in which the transmission power ratio is independently set for each combination of the modulation mode and encoding rate.

4. The communications system according to claim 1, wherein said transmission power control means controls a transmission power ratio of a pilot channel to the data channel as well as the transmission power ratio of the control channel to the data channel.

5. A transmitter for adaptively controlling a modulation mode and an encoding rate for data transmitted to a receiver, comprising:
adaptive modulation control means for controlling a modulation mode and an encoding rate in accordance with a channel quality notified from said receiver; and
transmission power control means for controlling a transmission power ratio of a control channel to a data channel in accordance with a control channel error detection result notified from said receiver and the modulation mode and encoding rate.

6. The transmitter according to claim 5, wherein said transmission power control means includes:
means for independently calculating a control channel error ratio for each combination of the modulation mode and encoding rate determined by said adaptive modulation control means; and
means for variably controlling the transmission power ratio of the control channel to the data channel in accordance with the control channel error ratio.

7. The transmitter according to claim 5, wherein said transmission power control means controls the transmission power ratio of the control channel to the data channel within a range in which the transmission power ratio is independently set for each combination of the modulation mode and encoding rate.

8. The transmitter according to claim 5, wherein said transmission power control means controls a transmission power ratio of a pilot channel to the data channel as well as the transmission power ratio of the control channel to the data channel.

9. A communication control method for adaptively controlling a modulation mode and an encoding rate for data transmitted from a transmitter to a receiver, comprising the steps of:
measuring a channel quality in said receiver;
detecting a control channel error in said receiver;
notifying the channel quality and the control channel error from said receiver to said transmitter;
controlling, in said transmitter, a modulation mode and an encoding rate in accordance with the channel quality notified from said receiver; and
controlling, in said transmitter, a transmission power ratio of a control channel to a data channel in accordance with a control channel error detection result notified from said receiver and the modulation mode and encoding rate.

10. The communication control method according to claim 9, wherein said step of controlling a transmission power ratio includes the steps of:
calculating a control channel error ratio independently for each combination of the modulation mode and encoding rate; and
variably controlling the transmission power ratio of the control channel to the data channel in accordance with the control channel error ratio.

11. The communication control method according to claim 9, wherein said step of controlling a transmission power ratio includes the step of controlling the transmission power ratio of the control channel to the data channel within a range in which the transmission power ratio is independently set for each combination of the modulation mode and encoding rate.

12. The communication control method according to claim 9, comprising the step of controlling a transmission power ratio of a pilot channel to the data channel in accordance with a control channel error detection result notified from said receiver, and the modulation mode and encoding rate.

13. A transmission control method in a transmitter for adaptively controlling a modulation mode and an encoding rate for data transmitted to a receiver comprising the steps of:
controlling the modulation mode and encoding rate in accordance with a channel quality notified from said receiver; and
controlling a transmission power ratio of a control channel to a data channel in accordance with a control channel error detection result notified from said receiver and the modulation mode and encoding rate.

14. The communication control method according to claim 13, comprising the step of controlling a transmission power ratio of a pilot channel to the data channel in accordance with the control channel error detection result notified from said receiver and the modulation mode and encoding rate.
